(19) United States
(12) Patent Application Publication
(10) Pub. No.: US 2024/0271713 A1
(43) Pub. Date: Aug. 15, 2024

(54) HEAT INTERFERENCE PREVENTION VALVE AND VALVE APPARATUS INCLUDING SAME

(71) Applicant: HYUHDAI WIA CORPORATION, Gyeongsangnam-do (KR)

(72) Inventors: Je Min YEON, Incheon (KR); Sang Min LEE, Gyeonggi-do (KR)

(21) Appl. No.: 18/430,137

(22) Filed: Feb. 1, 2024

(30) Foreign Application Priority Data
Feb. 14, 2023 (KR) 10-2023-0019455

(51) Int. Cl. F16K 27/06; F16K 11/085

(52) U.S. Cl. CPC F16K 27/065; F16K 11/0853

(57) ABSTRACT

A heat interference prevention valve that selectively circulates cooling media through a plurality of heat management parts using one valve. The valve includes flow paths isolated by a heat interference prevention part inside the valve, thereby minimizing heat interference between cooling media circulating through the respective flow paths, enabling efficient management of the temperature of the cooling medium, and managing and maintaining the heat management parts through which the cooling medium circulates at required temperatures.

### CROSS REFERENCE TO RELATED APPLICATION

This application is based on and claims priority under 35 U.S.C. 119 to Korean Patent Application No. 10-2023-0019455, filed on Feb. 14, 2023, in the Korean Intellectual Property Office, the disclosure of which is herein incorporated by reference in its entirety.

### BACKGROUND

### Field

The present disclosure relates to a heat interference prevention valve that has a plurality of flow paths formed in the valve and minimizes heat interference between cooling media when cooling media of different temperatures circulate through the respective flow paths, and a valve apparatus including the same.

### Description of the Related Art

Recently, with the proliferation of eco-friendly vehicles such as electric vehicles and fuel cell vehicles, many technologies related thereto have been developed. In particular, eco-friendly vehicles are driven using electric energy such as batteries, so development of technology is required to improve electric mileage.

Although the efficiency of the battery or drive motor is important to the electric mileage, since the vehicle without an engine has no heat source, heat management in the vehicle must be performed using electric energy.

In the eco-friendly vehicles, parts that require heat management are largely divided into batteries, electronic equipment, and interior air conditioning, and it is necessary to actively recycle waste heat by managing all the parts as an integrated system rather than managing each of them as an independent system, thereby increasing overall energy consumption efficiency.

However, since cooling water circulates through parts that require cooling, such as batteries, PE parts, and the like for cooling and since the optimal temperature differs between the parts, the temperature of the cooling water must be controlled.

However, conventionally, as the valves that determine the circulation of cooling water for the respective parts are integrated, cooling water of different temperatures may pass through the valve, causing heat interference. For example, if the temperature of the cooling water circulating in PE parts is managed at 70 degrees C. and the temperature of the cooling water circulating in the battery is managed at 30 degrees C., when the cooling waters of different temperatures pass through the valve, they exchange heat with each other, thereby failing to manage the cooling water at an appropriate temperature. In other words, if the temperature of the battery rises due to a change in the temperature of the cooling water when passing through the valve, the operating efficiency of the battery may deteriorate.

The foregoing described as the background art is intended merely to aid in the understanding of the background of the present disclosure, and is not intended to mean that the present disclosure falls within the purview of the related art already known to those skilled in the art.

### SUMMARY

The present disclosure has been made in order to solve the above-mentioned problems in the prior art and an aspect of the present disclosure is to provide a heat interference prevention valve that has a plurality of flow paths formed in the valve and minimizes heat interference between cooling media when cooling media of different temperatures circulate through the respective flow paths, and a valve apparatus including the same.

A heat interference prevention valve according to the present disclosure may include: a plurality of circulation holes disposed along an outer surface of the valve so as to be spaced apart from each other; a plurality of flow paths extending inside the same so as to lead to at least two or more circulation holes so that a cooling medium circulates through the circulation holes; and a heat interference prevention part disposed between the plurality of flow paths to isolate the respective flow paths.

The heat interference prevention part may extend from an inner surface of the valve between the circulation holes toward a center of the valve so as to be disposed between the respective flow paths, and may be formed to become narrower in its width toward the inner side.

The heat interference prevention part may be an empty space between partitions forming the flow paths.

The heat interference prevention part may be filled with a material with low thermal conductivity.

The heat interference prevention part may have a rib extending across the same and connected to the partition that forms the flow path.

According to another aspect of the present disclosure, a valve apparatus may include: a housing having a valve mounting part with an inner space and port parts to which a plurality of heat management parts is connected; a valve provided to be rotatable on the valve mounting part and having a plurality of circulation holes along an outer surface of the valve, a plurality of flow paths formed inside the same so as to lead to at least two circulation holes, and a heat interference prevention part formed between the flow paths to isolate the respective flow paths; and an actuator mounted to the housing and connected to the valve to determine the rotational position of the valve.

The valve apparatus may further include a sealing member provided between an inner circumferential surface of the valve mounting part and an outer circumferential surface of the valve and having through-holes formed to lead to the port parts and be selectively matched to the circulation holes depending on a position of the valve.

The inner circumferential surface of the valve mounting part may be formed in a cylindrical shape, and the outer circumferential surface of the valve may be formed in a cylindrical shape such that the outer circumferential surface faces the inner circumferential surface of the valve mounting part, and the sealing member may be formed in a cylindrical shape and fixed in its position in the state of being inserted into the valve mounting part, so that the valve may rotate relative to the sealing member.

The actuator may have a connecting shaft provided to be connected to a center of the valve, and the heat interference prevention part of the valve may be configured to have a connecting shaft between the respective flow paths.

The valve may have a partition forming the flow path inside the same, and the partition may be disposed to be spaced apart from the connecting shaft, and the heat interference prevention part may be formed between the partition and the connecting shaft.

The heat interference prevention valve in the structure described above and the valve apparatus including the same may selectively circulate cooling media through a plurality of heat management parts using one valve, and the flow paths inside the valve may be isolated by a heat interference prevention part, thereby minimizing heat interference between cooling media circulating through the respective flow paths, and accordingly, the temperature of the cooling medium is able to be efficiently managed, and the heat management parts through which the cooling medium circulates are able to be managed and maintained at required temperatures.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 is a diagram illustrating a valve apparatus according to the present disclosure;

FIG. 2 is a diagram illustrating a heat interference prevention valve according to an embodiment of the present disclosure;

FIG. 3 is a diagram illustrating a heat interference prevention valve according to another embodiment of the present disclosure; and

FIG. 4 is a diagram illustrating a heat interference prevention valve according to another embodiment of the present disclosure.

### DETAILED DESCRIPTION

Hereinafter, embodiments disclosed in the present specification will be described in detail with reference to the accompanying drawings, and the same or similar elements are given the same and similar reference numerals, so duplicate descriptions thereof will be omitted.

The terms “module” and “unit” used for the elements in the following description are given or interchangeably used in consideration of only the ease of writing the specification, and do not have distinct meanings or roles by themselves.

In describing the embodiments disclosed in the present specification, when the detailed description of the relevant known technology is determined to unnecessarily obscure the gist of the present disclosure, the detailed description may be omitted. Furthermore, the accompanying drawings are provided only for easy understanding of the embodiments disclosed in the present specification, and the technical spirit disclosed herein is not limited to the accompanying drawings, and it should be understood that all changes, equivalents, or substitutes thereof are included in the spirit and scope of the present disclosure.

Terms including an ordinal number such as “first”, “second”, or the like may be used to describe various elements, but the elements are not limited to the terms. The above terms are used only for the purpose of distinguishing one element from another element.

In the case where an element is referred to as being “connected” or “coupled” to any other element, it should be understood that another element may be provided therebetween, as well as that the element may be directly connected or coupled to the other element. In contrast, in the case where an element is “directly connected” or “directly coupled” to any other element, it should be understood that no other element is present therebetween.

A singular expression may include a plural expression unless they are definitely different in a context.

As used herein, the expression “include” or “have” are intended to specify the existence of mentioned features, numbers, steps, operations, elements, components, or combinations thereof, and should be construed as not precluding the possible existence or addition of one or more other features, numbers, steps, operations, elements, components, or combinations thereof.

The present disclosure may be variously modified and include various exemplary embodiments in which specific exemplary embodiments will be described in detail hereinbelow. However, it shall be understood that the specific exemplary embodiments are not intended to limit the present disclosure thereto and cover all the modifications, equivalents and substitutions which belong to the idea and technical scope of the present disclosure.

Hereinafter, a heat interference prevention valve according to a preferred embodiment of the present disclosure and a valve apparatus including the same will be described with reference to the attached drawings.

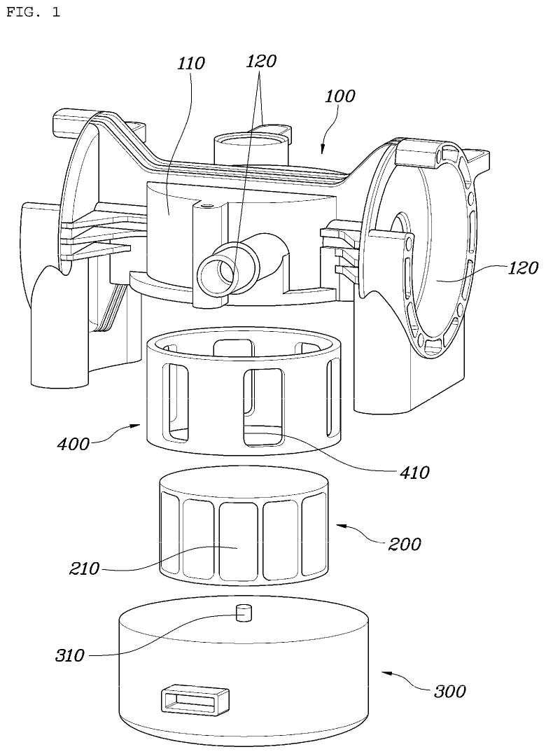

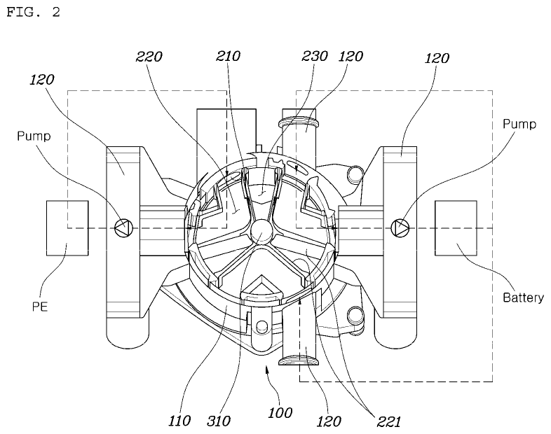

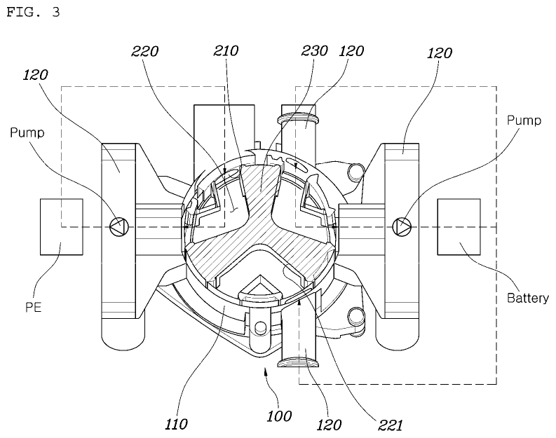

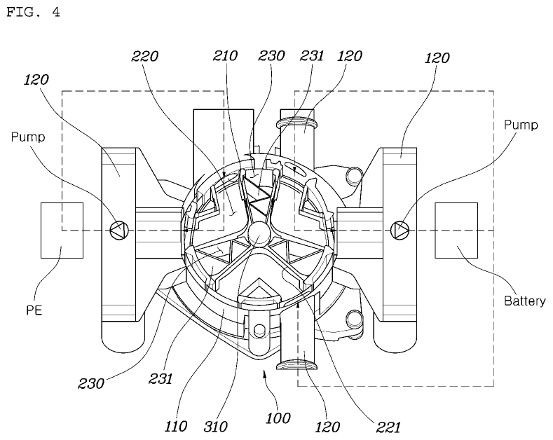

FIG. 1 is a diagram illustrating a valve apparatus according to the present disclosure, FIG. 2 is a diagram illustrating a heat interference prevention valve according to an embodiment of the present disclosure, FIG. 3 is a diagram illustrating a heat interference prevention valve according to another embodiment of the present disclosure, and FIG. 4 is a diagram illustrating a heat interference prevention valve according to another embodiment of the present disclosure.

As shown in FIGS. 1 and 2, a heat interference prevention valve according to the present disclosure includes: a plurality of circulation holes 210 spaced apart from each other along the outer surface; a plurality of flow paths 220 extending in the inside so as to lead to at least two circulation holes 210 and allowing the cooling medium to circulate through the circulation holes 210; and heat interference prevention parts 230 disposed between the plurality of flow paths 220 to isolate the respective flow paths 220. Here, the cooling medium may be cooling water.

The heat interference prevention valve 200 according to the present disclosure has a plurality of circulation holes 210 formed on the outer surface, and a flow path 220 extends to lead to at least two circulation holes 210 inside thereof, causing the cooling medium to circulate through the circulation holes 210.

Although six circulation holes 210 are formed and three flow paths 220 leading to two circulation holes 210 are shown in the drawing of the present disclosure, the number of circulation holes 210 and flow paths 220 may be designed in various ways.

The flow path 220 is formed by a partition 221 inside the valve 200, and the partition 221 extends from the inner surface of the valve 200 so as to lead to at least two circulation holes 210. That is, a pair of partitions 221 forms one flow path 220.

This partition 221 may be formed in a curved shape in consideration of the positions of the circulation holes 210 and the flowability of the cooling medium flowing into the valve 200 through the circulation holes 210.

In particular, a heat interference prevention part 230 is formed between the plurality of flow paths 220 inside the valve 200. The heat interference prevention part 230 is disposed between the plurality of flow paths 220 to space the flow paths 220 apart from each other, thereby minimizing heat exchange between cooling media circulating through the respective flow paths 220.

That is, conventionally, although a plurality of flow paths 220 is formed inside the valve 200, some flow paths 220 are configured to join each other, so that when cooling media with different temperatures enter the valve 200, the cooling media are mixed and the temperature changes. At this time, if the cooling medium circulating through a heat management part managed at a high temperature exchanges heat with the cooling media circulating through a heat management part managed at a lower temperature, the temperature of the heat management part managed at a low temperature increases.

In the present disclosure, a plurality of flow paths 220 is formed inside the valve 200, and the plurality of flow paths 220 is isolated by a heat interference prevention part 230 to prevent heat exchange between the cooling media circulating through the respective flow paths 220, thereby securing cooling efficiency of the heat management parts managed at high temperatures and the heat management parts managed at lower temperatures.

Describing the above-mentioned heat interference prevention part 230 in detail, as shown in FIG. 2, the heat interference prevention part 230 may extend from the inner surface of the valve 200 between the circulation holes 210 to the center of the valve 200 so as to be disposed between the respective flow paths 220, and may be formed to become narrower in width toward the center thereof.

As described above, the heat interference prevention part 230 may be formed such that the width thereof gradually decreases from the outside to the inside to secure a space where the flow paths 220 are formed inside the valve 200. That is, the flow paths 220 may extend so as to lead to a plurality of circulation holes 210 and may be formed in a curved shape in order to secure the flowability of the cooling medium flowing into the valve 200 through the circulation holes 210. Accordingly, a space must be secured inside the valve 200 so that the flow path 220 may be formed in a curved shape. To this end, the heat interference prevention part 230 may be formed such that the width thereof gradually decreases from the outside to the inside, thereby securing a space where the flow path 220 may be formed inside the valve 200, and accordingly, the flow path 220 may be formed in various shapes such as a curved shape and the like.

Meanwhile, as an embodiment according to the present disclosure, as shown in FIG. 2, the heat interference prevention part 230 may be configured as an empty space between the partitions 221 forming the flow paths 220.

The partitions 221 extend to form the flow path 220 including at least two or more circulation holes 210 inside the valve 200, and heat interference prevention part 230 is provided between the partitions 221 forming different flow paths 220. That is, as the partition 221 forming one flow path 220 and the partition 221 forming another flow path 220 are spaced apart from each other, a separation space is produced between the partitions 221 of the respective flow paths 220, and the corresponding separation space is configured as the heat interference prevention part 230.

As described above, the heat interference prevention part 230 may be formed as an empty space of an air layer between the different flow paths 220, thereby avoiding heat exchange between the cooling media circulating through the respective flow paths 220.

As another example, as shown in FIG. 3, the heat interference prevention part 230 may be filled with a material with low thermal conductivity.

As the heat interference prevention part 230 disposed between the respective flow paths 220 is made of a material with low thermal conductivity described above, heat exchange between the cooling media circulating through the respective flow paths 220 is blocked by the heat interference prevention part 230. Here, the material with low thermal conductivity may include water, oil, stainless steel, and the like.

Since the heat interference prevention part 230 is made of a material with low thermal conductivity described above, it is possible to minimize transfer of heat from the cooling medium circulating through one flow path 220 to the cooling medium circulating through another flow path 220.

Meanwhile, as another embodiment, as shown in FIG. 4, the heat interference prevention part 230 may have a rib 231 extending across the same and connected to the partition 221 forming the flow path 220.

The heat interference prevention part 230 may be configured as a separation space between the partition 221 forming one flow path 220 and the partition 221 forming another flow path 220. In particular, in the heat interference prevention part 230, the rib 231 may extend in a straight or curved line to be connected to the partitions 221 of different flow paths 220, thereby securing the overall rigidity of the valve 200.

Although the thickness of the partition 221 forming the flow path 220 may be increased to obtain the internal rigidity of the valve 200, if the thickness of the partition 221 is increased, the width of the flow path 220 may become smaller. Therefore, the heat interference prevention part 230 has a plurality of ribs 231 extending therein, and the ribs 231 connect the partitions 221 of different flow paths 220 to form a support structure, so that heat exchange between the cooling media circulating through the respective flow paths 220 may be minimized by the heat interference prevention part 230, and the overall rigidity of the valve 200 may be secured, thereby improving durability.

The rib 231 of the heat interference prevention part 230 may be applied in various forms, and its shape and thickness may be designed in various ways depending on the required rigidity of the valve 200.

Meanwhile, the valve apparatus according to the present disclosure, as shown in FIG. 1, includes a housing 100 having a valve mounting part 110 with an inner space and a port part 120 to which a plurality of heat management parts is connected; a valve 200 provided to be rotatable on the valve mounting part 110 and having a plurality of circulation holes 210 formed along the outer surface, a plurality of flow paths 220 formed inside the same so as to lead to at least two circulation holes 210, and a heat interference prevention part 230 formed between the flow paths 220 to isolate the respective flow paths 220; and an actuator 300 mounted to the housing 100 and connected to the valve 200 to determine the rotational position of the valve 200.

The valve mounting part 110 on which the valve 200 is provided is formed inside the housing 100, and the valve 200 is provided to be rotatable on the valve mounting part 110. The valve mounting part 110 is formed inside the housing 100 as described above, the structure for providing the valve 200 inside the housing 100 is able to be compacted.

An actuator 300 and a reservoir may be coupled to the top or bottom of the housing 100. The reservoir is configured to store the cooling medium and is not shown in the drawing. The actuator 300 is connected to the valve 200 and transmits rotational force so that the valve 200 rotates. In addition, a water pump may be mounted on the side of the housing 100, and the cooling medium may circulate through a battery or PE parts by the operation of the water pump. Here, the cooling medium may be cooling water.

A plurality of port parts 120 is provided on the valve mounting part 110 of the housing 100. Here, the plurality of port parts 120 may be disposed on the valve mounting part 110 so as to be spaced apart from each other, making it easy to connect lines through which the cooling medium circulates to the port parts 120 and preventing the port parts 120 from interfering with other parts.

Meanwhile, a sealing member 400 may be further included to be provided between the inner circumferential surface of the valve mounting part 110 and the outer circumferential surface of the valve 200 and to have through-holes 410 formed to lead to the port parts 120 and be selectively matched to the circulation holes 210 depending on the position of the valve 200.

The sealing member 400 may be inserted into the valve mounting part 110 of the housing 100 and then fixed in its position, and the valve 200 may rotate relative to the sealing member 400.

The through-holes 410 of the sealing member 400 may be formed to match the port parts 120 of the housing 100 and the circulation holes 210 of the valve 200.

Accordingly, portions of the sealing member 400, excluding the through-holes 410, may have a sealed shape, so that the cooling medium circulates through the circulation hole 210 matched to the through-hole 410 depending on the rotational position of the valve 200, whereas the cooling media is unable to circulate through the circulation hole 210 blocked and closed by the sealing member 400.

Meanwhile, the valve mounting part 110 may have an inner circumferential surface formed in a cylindrical shape, and the valve 200 may have an outer circumferential surface formed in a cylindrical shape such that the outer circumferential surface faces the inner circumferential surface of the valve mounting part 110, and the sealing member 400 may be formed in a cylindrical shape and fixed in its position in the state of being inserted into the valve mounting part 110, so that the valve 200 may rotate relative to the sealing member 400.

The valve mounting part 110 may be formed in a cylindrical shape and provided inside the housing 100 to have a shape recessed toward the inside of the housing 100. The valve 200 in a cylindrical shape is inserted into the valve mounting part 110 and rotates about its axis.

In addition, the sealing member 400 is also formed in a cylindrical shape and comes into contact with the inner circumferential surface of the valve mounting part 110 and the outer circumferential surface of the valve 200. The sealing member 400 is fixed to the valve mounting part 110 of the housing 100 and the valve 200 rotates relative to the sealing member 400.

The actuator 300 may have a connecting shaft 310 provide to be connected to the center of the valve 200, and the heat interference prevention part 230 of the valve 200 may be configured to have the connecting shaft 310 between the respective flow paths 220.

In the present disclosure, the valve 200 may be configured to be rotatable, and the connecting shaft 310 of the actuator 300 may be coupled to the center of the valve 200 so that the valve 200 may rotate about its axis.

In particular, as shown in FIG. 2, the connecting shaft 310 of the actuator 300 may be coupled to the valve 200 so as to pass therethrough in order to ensure firm coupling to the valve 200. Here, the heat interference prevention part 230 inside the valve 200 is formed to include the connecting shaft 310, thereby preventing heat transfer through the connecting shaft 310.

Specifically, the valve 200 has a partition 221 forming a flow path 220 inside the same, and the partition 221 is disposed to be spaced apart from the connecting shaft 310, and a heat interference prevention part 230 may be formed between the partition 221 and the connecting shaft 310.

In other words, if the partition 221 forming the flow path 220 inside the valve 200 is located adjacent to the connecting shaft 310, the heat of the cooling medium circulating through each flow path 220 may be transferred to the connecting shaft 310, so that the heat of each cooling medium may be transmitted through the connecting shaft 310.

Accordingly, the heat interference prevention part 230 is configured to include the connecting shaft 310, thereby blocking heat transfer through the connecting shaft 310.

The heat interference prevention valve in the structure described above and the valve apparatus including the same may selectively circulate cooling media through a plurality of heat management parts using one valve 200, and the flow paths 220 inside the valve 200 may be isolated by the heat interference prevention part 230, thereby minimizing heat interference between cooling media circulating through the respective flow paths 220, and accordingly, the temperature of the cooling medium is able to be efficiently managed, and the heat management parts through which the cooling medium circulates are able to be managed and maintained at required temperatures.

Although the present disclosure has been described and illustrated in conjunction with particular embodiments thereof, it will be apparent to those skilled in the art that various improvements and modifications may be made to the present disclosure without departing from the technical idea of the present disclosure defined by the appended claims.

What is claimed is:

1. A heat interference prevention valve comprising:
a plurality of circulation holes disposed along an outer surface of the valve so as to be spaced apart from each other;
a plurality of flow paths extending inside the valve and configured to lead to at least two or more circulation holes so that a cooling medium circulates through the circulation holes; and
a heat interference prevention part disposed between the plurality of flow paths to isolate the respective flow paths.

2. The heat interference prevention valve according to claim 1, wherein the heat interference prevention part extends from an inner surface of the valve between the circulation holes toward a center of the valve so as to be disposed between the respective flow paths, and is formed to become narrower in its width toward the inner side.

3. The heat interference prevention valve according to claim 1, wherein the heat interference prevention part is an empty space between partitions forming the flow paths.

4. The heat interference prevention valve according to claim 1, wherein the heat interference prevention part is filled with a material with low thermal conductivity.

5. The heat interference prevention valve according to claim 1, wherein the heat interference prevention part has a rib extending across the valve and connected to a partition that forms the flow path.

6. A valve apparatus comprising:
a housing having a valve mounting part with an inner space and port parts to which a plurality of heat management parts is connected;
a valve provided to be rotatable on the valve mounting part and having a plurality of circulation holes along an outer surface of the valve, a plurality of flow paths formed inside the valve and configured to lead to at least two circulation holes, and a heat interference prevention part formed between the flow paths to isolate the respective flow paths; and
an actuator mounted to the housing and connected to the valve to determine the rotational position of the valve.

7. The valve apparatus according to claim 6, further comprising a sealing member provided between an inner circumferential surface of the valve mounting part and an outer circumferential surface of the valve and having through-holes formed to lead to the port parts and be selectively matched to the circulation holes depending on a position of the valve.

8. The valve apparatus according to claim 7, wherein the inner circumferential surface of the valve mounting part is formed in a cylindrical shape,
the outer circumferential surface of the valve is formed in a cylindrical shape such that the outer circumferential surface faces the inner circumferential surface of the valve mounting part, and
the sealing member is formed in a cylindrical shape and fixed in its position in the state of being inserted into the valve mounting part, so that the valve rotates relative to the sealing member.

9. The valve apparatus according to claim 6, wherein the actuator has a connecting shaft provided to be connected to a center of the valve, and
the heat interference prevention part of the valve is configured to have a connecting shaft between the respective flow paths.

10. The valve apparatus according to claim 9, wherein the valve has a partition forming the flow path inside the valve, the partition is disposed to be spaced apart from the connecting shaft, and the heat interference prevention part is formed between the partition and the connecting shaft.
